(19) United States
(12) Patent Application Publication
(10) Pub. No.: US 2014/0260793 A1
(43) Pub. Date: Sep. 18, 2014

(54) STARTER MOTOR FOR A MOTOR VEHICLE

(71) Applicant: REMY TECHNOLOGIES, L.L.C., Pendleton, IN (US)

(72) Inventors: Keith J. Murphy, Simsbury, CT (US); Kirk Neet, Pendleton, IN (US)

(73) Assignee: REMY TECHNOLOGIES, L.L.C., Pendleton, IN (US)

(21) Appl. No.: 14/169,731

(22) Filed: Jan. 31, 2014

Related U.S. Application Data
(60) Provisional application No. 61/792,091, filed on Mar. 15, 2013.

(51) Int. Cl. F02N 11/02

(52) U.S. Cl. CPC F02N 11/02
USPC 74/7 A

(57) ABSTRACT

A starter motor includes a motor portion having a stationary field, an armature rotatable relative to the stationary field, an armature shaft coupled to the armature, and a pinion gear slideably disposed relative to the armature shaft and rotatably fixed relative to the armature. The starter motor also includes a solenoid mounted to the motor portion. The solenoid includes a plunger mechanically linked with the pinion gear. The solenoid is configured and disposed to cause the pinion gear to engage with a flywheel as the armature shaft reaches a speed between about 150 RPM and about 250 RPM.

### CROSS-REFERENCE TO RELATED APPLICATION

This application is a Non-Provisional of U.S. Provisional Application Ser. No. 61/792,091 filed Mar. 15, 2013, the disclosure of which is incorporated by reference herein in its entirety.

### BACKGROUND OF THE INVENTION

Exemplary embodiments pertain to the art of motor vehicles and, more particularly, to a starter motor for a motor vehicle.

Motor vehicles employ a variety of power plants to provide a motive force. Conventionally, power plants include internal combustion engines that utilize either gas fuel or diesel fuel. Currently, many motor vehicles include a hybrid power plant that combines aspects of an internal combustion engine with an electric engine. Internal combustion engines include a starter motor that provides an initial motive force required to begin engine rotation for ignition. The starter motor typically includes a pinion gear that engages with a ring gear on the internal combustion engine. Once engaged, the starter motor rotates to initiate operation of the internal combustion engine. Once the engine is in operation, the pinion gear is withdrawn from the ring gear.

Many newer vehicles include a start/stop system. The start/stop system shuts off the internal combustion engine when the motor vehicle comes to a stop. Shutting off the internal combustion engine while the motor vehicle is not in motion reduces fuel consumption and lowers emissions. Generally, the motor vehicle will include a controller that initiates shut-off of the internal combustion engine upon sensing application of a braking system. Specifically, upon activation of the braking system, the internal combustion engine is shut down and allowed to coast to a stop as the vehicle draws to a stop. Application of an accelerator input leads to re-ignition of the internal combustion engine.

Occasionally, the need to stop the motor vehicle may change. Prior to coming to a full stop, a traffic light may change from red to green, an obstacle may be perceived, or some other factor may cause a driver to reconsider his decision to apply the braking system. In such cases, it is necessary to restart the internal combustion engine. When the internal combustion engine is rotating at speeds above about 400 RPM, restarting generally does not require a starter engagement. At speeds below about 400 RPMs, starter engagement is typically necessary. At speeds below about 90 RPM, engagement of the pinion gear and ring gear generally occurs without much interference. At engine speeds between about 90 RPM and about 400 RPM, interference may occur with a stopped starter leading to substantial noise and wear. It is desirable to reduce noise and wear when engaging a pinion gear from a starter with a ring gear that is in motion.

### BRIEF DESCRIPTION OF THE INVENTION

Disclosed is a starter motor including a motor portion having a stationary field, an armature rotatable relative to the stationary field, an armature shaft coupled to the armature, and a pinion gear slideably disposed relative to the armature shaft and rotatably fixed relative to the armature. The starter motor also includes a solenoid mounted to the motor portion. The solenoid includes a plunger mechanically linked with the pinion gear. The solenoid is configured and disposed to cause the pinion gear to engage with a flywheel as the armature shaft reaches a speed between about 150 RPM and about 250 RPM.

Also disclosed is a method of operating a starter motor for a motor vehicle. The method includes rotating an armature shaft in a motor portion of the starter motor, activating a solenoid mounted to the motor portion shifting a pinion gear rotatably fixed to the armature shaft toward a flywheel, and engaging the pinion gear and the flywheel when the armature shaft reaches a speed of between about 150 RPM and about 250 RPM.

### BRIEF DESCRIPTION OF THE DRAWINGS

The following descriptions should not be considered limiting in any way. With reference to the accompanying drawings, like elements are numbered alike:

FIG. 1 depicts a starter motor and solenoid in accordance with an exemplary embodiment;

FIG. 2 depicts a graph illustrating pinion speed and stroke length of the starter motor of FIG. 1; and

FIG. 3 depicts a graph illustrating pinion speed and plunger stroke speed of the starter motor of FIG. 1.

### DETAILED DESCRIPTION OF THE INVENTION

A detailed description of one or more embodiments of the disclosed apparatus and method are presented herein by way of exemplification and not limitation with reference to the Figures.

A starter motor in accordance with an exemplary embodiment is indicated generally at 2. Starter motor 2 includes a motor portion 4 and a solenoid 6. Motor portion 4 includes a motor housing 8 that surrounds a stationary field 12 and an armature 14. Armature 14 is supported in motor housing 8 through an armature shaft 16 and includes a commutator (not shown) that is linked to a source of electoral energy (also not shown) through a plurality of motor brushes (not shown). Armature shaft 16 supports a bearing 18 and is operatively connected to a pinion shaft 20. Pinion shaft 20 supports a pinion gear 24 that is selectively shifted into engagement with a flywheel 25. Pinion gear 24 is rotatably fixed relative to pinion shaft 20 and armature shaft 16.

Solenoid 6 includes a housing 26 that surrounds one or more coils (not shown). The coils are connected to terminals 28 and surround a solenoid plunger 30. Solenoid plunger 30 is configured to act upon bearing 18 to shift pinion gear 24 along pinion shaft 20. Electrical current flows from the source of electrical energy to terminals 28. The electrical current passes to the coils in solenoid 6 and to the motor brushes. As will be discussed more fully below, the current flowing to the solenoid 6 causes plunger 30 to retract at a specific speed and distance, collectively referred to herein as parameter. The electrical current flowing to the motor brushes passes through the commutator, and into the armature 14. The electrical current sets up a field in the armature 14 that interacts with stationary field 12. The interaction of the fields results in rotation of armature 14.

In accordance with an exemplary embodiment, contrary to prior art systems in which the pinion gear does not begin to rotate until engaged with the flywheel, the present invention ensures that pinion gear 24 is rotating at a desired speed upon engagement with flywheel 25. It has been shown that maintaining a speed of a pinion gear within about 200 RPM of the speed of a flywheel allows for a satisfactory engagement. In accordance with an aspect of the exemplary embodiment, solenoid 6 is configured to engage pinion gear 24 with flywheel 25 when armature shaft 16 is rotating between about 150 RPM and about 250 RPM. In accordance with another aspect of the exemplary embodiment, solenoid 6 is configured to engage pinion gear 24 with flywheel 25 when armature shaft 16 is rotating at about 200 RPM. It should be understood that pinion gear 24 is spinning, or rotating, at the moment of engagement with flywheel 25.

In accordance with an aspect of the exemplary embodiment, solenoid plunger 30 and linkage system 34 establish a predetermined stroke length. The predetermined stroke length establishes a desired engagement distance for shifting pinion gear 24 along pinion shaft 20. As shown in FIG. 2, rotational speed of armature shaft 16 achieved from stop relates to engagement distance (and therefore time) of pinion gear 24 moving from a disengaged position to an engaged position. The shorter the engagement distance, the lower the armature 14 speed at the time of engagement. Conversely, the longer the engagement distance, the higher the rotational speed of the armature 14 at the time of engagement. In accordance with one aspect of the exemplary embodiment, the engagement distance is at least 3 mm. In accordance with another aspect of the exemplary embodiment, the engagement distance is at least 5 mm. In accordance with still another aspect of the exemplary embodiment, the engagement distance is at least 9 mm. Pinion shaft 20 establishes an engagement distance X for pinion gear 24 that enables armature shaft 16 to reach the desired rotational speed β.

In accordance with another aspect of the exemplary embodiment, solenoid plunger 30 and linkage system 34 establish an engagement speed of pinion gear 24. The engagement speed moves pinion gear 24 along pinion shaft 20 at a desired rate. As shown in FIG. 3, rotational speed of armature shaft 16 relates to engagement speed of pinion gear 24. The shorter the engagement speed, the lower the armature 14 speed at the time of engagement. Conversely, the longer the engagement speed, the higher the rotational speed of the armature 14 at the time of engagement. In accordance with the aspect of the exemplary embodiment pinion shaft 20 establishes an engagement speed “t” for pinion gear 24 that enables armature shaft 16 to reach the desired rotational speed β. The engagement speed provides sufficient time for armature shaft 16 to reach the desired speed at the moment of engagement of pinion gear 24 and flywheel 25.

At this point it should be understood that the exemplary embodiments describe a starter motor including a pinion gear that reaches a desired speed of rotation at the moment of engagement with a flywheel. Rotating the pinion gear at the desired speed enables satisfactory activation of the starter motor under conditions in which the flywheel is rotating at low speeds and when the flywheel is at a full stop.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A starter motor comprising:
a motor portion including a stationary field, an armature rotatable relative to the stationary field, an armature shaft coupled to the armature, and a pinion gear slideably disposed relative to the armature shaft and rotatably fixed relative to the armature;
a solenoid mounted to the motor portion, the solenoid including a plunger mechanically linked with the pinion gear, the solenoid being configured and disposed to cause the pinion gear to engage with a flywheel as the armature shaft reaches a speed between about 150 RPM and about 250 RPM.

2. The starter motor according to claim 1, wherein the solenoid is configured and disposed to cause the pinion gear to engage the flywheel as the armature shaft reaches a speed of about 200 RPM.

3. The starter motor according to claim 1, wherein the plunger is configured and disposed to extend from the solenoid with a defined engagement speed to shift the pinion gear into engagement with the flywheel, the defined engagement speed establishing the speed of the armature shaft.

4. The starter motor according to claim 1, wherein the plunger is configured and disposed to shift the pinion gear into engagement with the flywheel over a predetermined engagement distance, the predetermined engagement distance establishing the speed of the armature shaft.

5. The starter motor according to claim 1, wherein the solenoid includes a linkage system coupled between the plunger and the pinion gear, the linkage system being configured and disposed to shift the pinion gear relative to armature shaft an engagement distance of at least 3 mm.

6. The starter motor according to claim 5, wherein the linkage system is configured and disposed to shift the pinion gear relative to the armature shaft an engagement distance of at least 5 mm.

7. The starter motor according to claim 5, wherein the linkage system is configured and disposed to shift the pinion gear relative to the armature shaft an engagement distance of at least 9 mm.

8. A method of operating a starter motor for a motor vehicle, the method comprising:
rotating an armature shaft in a motor portion of the starter motor;
activating a solenoid mounted to the motor portion shifting a pinion gear rotatably fixed to the armature shaft toward a flywheel;
engaging the pinion gear and the flywheel when the armature shaft reaches a speed of between about 150 RPM and about 250 RPM.

9. The method of claim 8, wherein engaging the pinion gear and the flywheel includes shifting the pinion gear over a predetermined engagement distance.

10. The method of claim 9, wherein shifting the pinion gear over a predetermined engagement distance includes extending a plunger operatively connected to a solenoid and a linkage system.

11. The method of claim 10, wherein extending a plunger includes acting upon a linkage system mechanically linked to the plunger to shift the pinion gear over an engagement distance of at least 3 mm.

12. The method of claim 11 wherein extending a plunger includes acting upon a linkage system mechanically linked to the plunger to shift the pinion gear over an engagement distance of at least 5 mm.

13. The method of claim 12, wherein extending a plunger includes acting upon a linkage system mechanically linked to the plunger to shift the pinion gear over an engagement distance of at least 9 mm.

14. The method of claim 8, wherein engaging the pinion gear and the flywheel includes shifting the pinion gear over a predetermined engagement speed.
